(19) United States
(12) Patent Application Publication
(10) Pub. No.: US 2012/0049028 A1
(43) Pub. Date: Mar. 1, 2012

(54) SUPPORT BRACKET FOR RIGID PANELS

(76) Inventor: MARK W. BLEVINS, Morgantown, IN (US)

(21) Appl. No.: 13/182,282

(22) Filed: Jul. 13, 2011

Related U.S. Application Data
(60) Provisional application No. 61/378,279, filed on Aug. 30, 2010.

(51) Int. Cl. F16M 13/00

(52) U.S. Cl. 248/309.1

(57) ABSTRACT

The support bracket for rigid panels is used for the support and/or carriage of large, heavy, rigid panels of construction materials (e.g., drywall, plywood or other processed wood panels, glass, etc.) to elevated levels in building construction or the like. The bracket has a plate having upper and lower grips extending from the back of the plate. The grips are open on opposite sides, and are spaced apart to allow the bracket to pass over a support column such as an upright for a guardrail on a personnel lift. The bracket is then rotated so that both grips grasp the upright, and is then secured in place. The opposite side of the plate has a panel support flange extending therefrom for supporting and carrying a panel during transport on the lift. Two such brackets are preferably used, the panel being placed across both brackets for greater stability.

### CROSS-REFERENCE TO RELATED APPLICATION

This application claims the benefit of U.S. Provisional Patent Application Ser. No. 61/378,279, filed Aug. 30, 2010.

### BACKGROUND OF THE INVENTION

1. Field of the Invention

The present invention relates generally to brackets for supporting and securing sheet materials, and more particularly to a support bracket for rigid panels (such as wallboard, plywood, large panes of glass, and the like) as the panels are lifted to an elevated position for installation during building construction and similar projects.

2. Description of the Related Art

Virtually all building construction uses various large, bulky, and heavy panels at various points in the structure, generally in the finishing of interior walls and surfaces. Perhaps the most commonly used material is gypsum wallboard, usually called “drywall” in the United States. Drywall sheets are generally manufactured in four-foot widths and eight-foot lengths, but may be provided in greater lengths as desired. Thicknesses range from a relatively thin ¼ inch up to ⅝ inch. The gypsum plaster material used for the core of such panels is relatively heavy, with four by eight foot panels of ⅝ inch thickness weighing on the order of seventy pounds, depending upon the specific content for fire codes, etc.

Other large and rigid sheet panels can have comparable weights, as well. Sheets of plywood, chipboard, Masonite, and other wood materials or products of comparable size and thickness have about the same weights. Glass is even heavier, with a four by eight foot sheet of ¼ inch thick glass weighing on the order of one hundred pounds.

Clearly, transporting such large and heavy panels to the higher levels of a building under construction is not an easy task without the proper machinery and equipment to handle the job. In consideration of the weight of such panels, particularly gypsum wallboard or drywall panels, a number of devices have been developed in the past to aid in positioning such panels in place on a wall or ceiling frame for installation thereon.

Equipment for holding, supporting, or carrying such panels (including panels of other materials, such as plywood, glass, etc.) to the elevated levels of a structure for installation therein, is less well known. Oftentimes, a worker will balance such a sheet of material against the guardrail of a personnel lift, with the lower edge of the panel resting upon the worker's foot extending from beneath the guardrail structure. Clearly, this is not a secure method of transporting such panels, given that the worker may have to shift his position suddenly to maintain balance, or for some other reason.

Thus, a support bracket for holding rigid panels solving the aforementioned problems is desired.

### SUMMARY OF THE INVENTION

The support bracket for rigid panels includes a rigid metal plate having opposite upper and lower ends and opposite first and second edges. An upper grip extends from the first edge of the plate, and is open toward the opposite second edge. A lower grip is spaced below the upper grip and extends from the second edge, and is open toward the first edge. The two grips are spaced apart sufficiently to allow an anchor component, e.g., an upright of a personnel lift guardrail, to be placed therebetween. The support bracket is rotated to place both grips over the upright, and is then pinned or otherwise secured in place. The lower edge of the lower grip rests upon the edge of the floor of the lift.

A panel support structure extends from the face of the plate opposite the two grips. The panel support structure includes a flat, rigid surface or flange upon which the panel may rest. A retaining lip extends upward from the outer edge of the panel rest surface to prevent the panel from slipping past the end of the surface. The panel rest surface may comprise the top of a rectangular section tube that is welded or otherwise permanently and immovably affixed to the plate.

The entire panel support device is preferably constructed of relatively heavy sheet and rectangular tubular steel material, for strength and rigidity. The device is installed as described above, i.e., by positioning the anchor or attachment column or post between the two grips, rotating the device to position the grips around the column, and securing the device so that it cannot inadvertently rotate to fall from the column or post to which it has been secured. A second such panel support is preferably secured to a nearby column in the same manner. The two panel supports are used to support the lower edge of a heavy sheet of rigid material as it is lifted on a personnel lift or the like. The panel support is relatively economical to construct, thereby allowing virtually any construction worker who has need to transport large and heavy panels using a personnel lift or similar device to own a pair of such devices for use as described above.

These and other features of the present invention will become readily apparent upon further review of the following specification and drawings.

### BRIEF DESCRIPTION OF THE DRAWINGS

FIG. 1 is an environmental, perspective view of a boom lift having a pair of support brackets for rigid panels according to the present invention removably installed thereon, showing their operation in holding a rigid panel.

FIG. 2 is a partial environmental perspective view of a portion of a lift platform and the support bracket of FIG. 1 exploded therefrom, showing the support bracket disposed laterally before abutting the bracket against the post.

FIG. 3 is a partial environmental rear elevation view of the support bracket of FIG. 1, showing the bracket after rotation on the post so that the grip arms hook around opposite sides of the post.

FIG. 4 is a partial environmental front elevation view of the support bracket of FIG. 1, showing the support of a rigid panel by the support bracket.

Similar reference characters denote corresponding features consistently throughout the attached drawings.

### DETAILED DESCRIPTION OF THE PREFERRED EMBODIMENTS

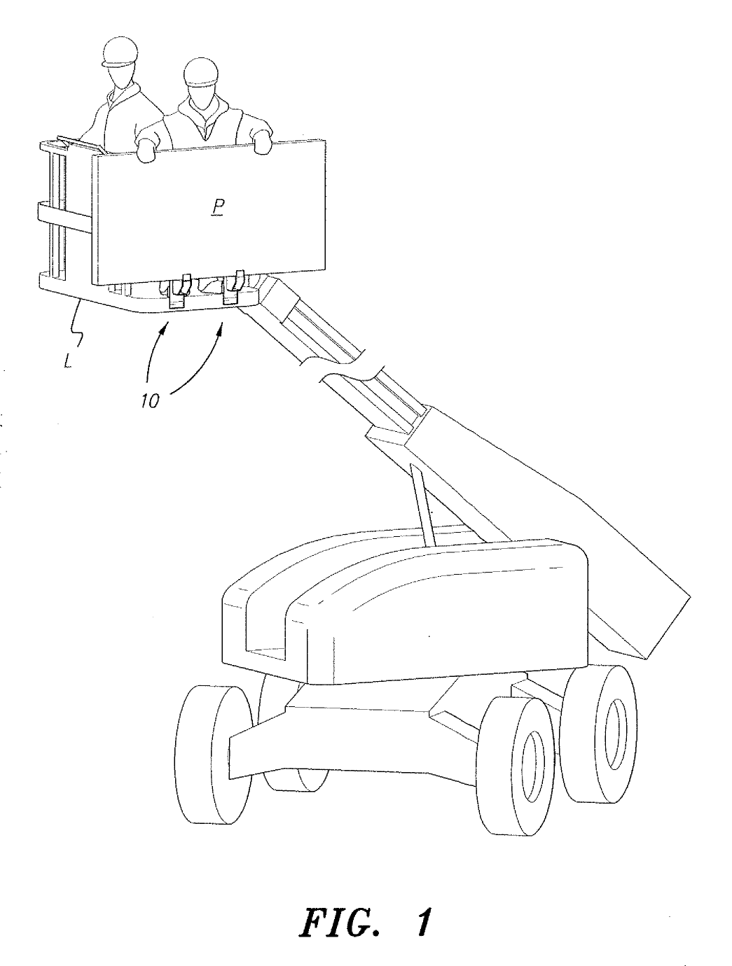

The support bracket for rigid panels is used for supporting and/or carrying large, heavy, rigid panels (e.g., drywall, Masonite, chipboard, large glass panels, etc.) to elevated levels for their installation in building construction or other work where such panels may be used. FIG. 1 of the drawings provides an environmental perspective view of two such brackets 10 temporarily and removably secured to the guard rail structure of a personnel lift L, the brackets 10 being used to support a large and heavy panel P as it is lifted into position.

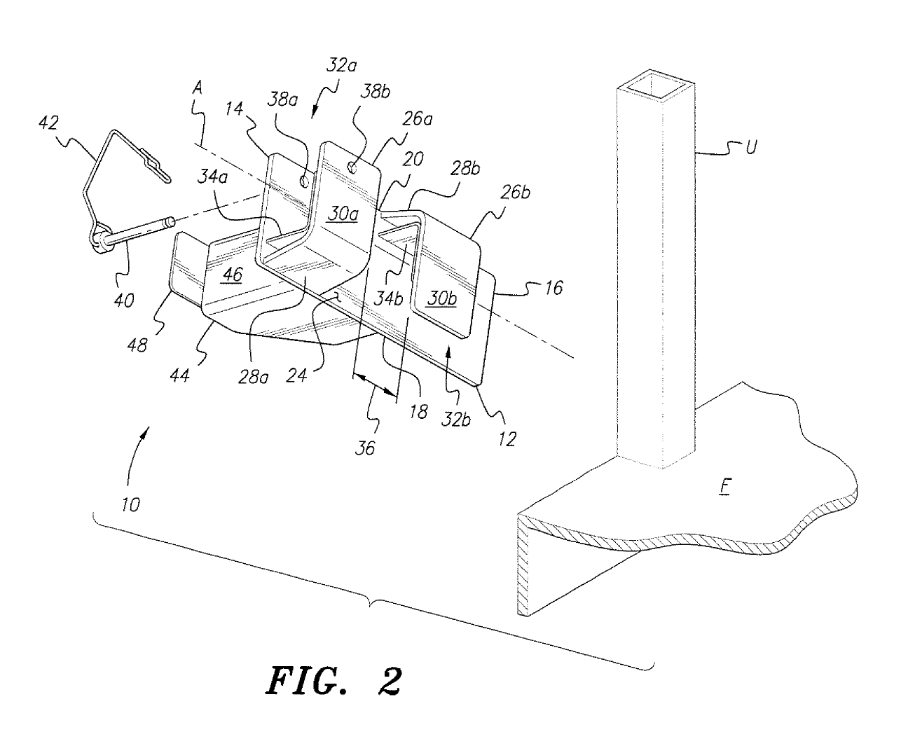

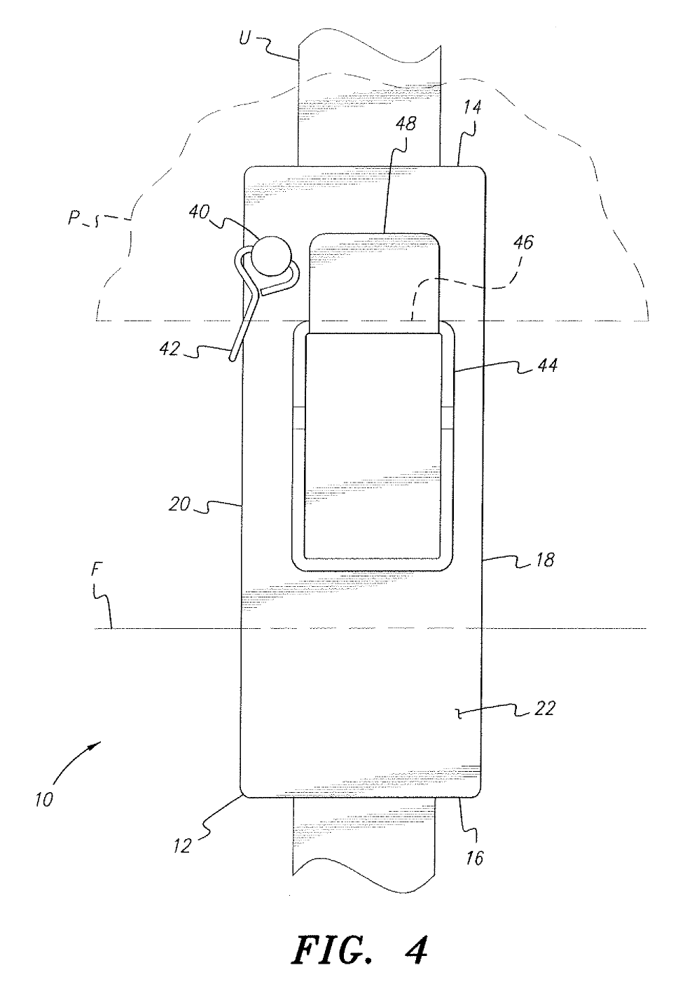

FIGS. 2 through 4 of the drawings provide further details of the support bracket 10. FIG. 2 illustrates its installation upon an upright U of the guardrail structure of the lift. The support bracket 10 includes a rigid plate 12 of steel or other suitable material that forms the center of the structure. The plate 12 has an upper end 14, an opposite lower end 16, a first edge 18, an opposite second edge 20, a first surface 22 (shown in FIG. 4), and an opposite second surface 24.

Two vertically and laterally spaced apart grips 26a and 26b extend from the second surface 24 of the plate 12. The two grips 26a, 26b are oriented essentially in mirror image to one another, comprising short lengths of steel angle, bent steel plate, or other suitable material. Each grip 26a, 26b comprises a short upstanding portion 28a, 28b extending at an acute angle to the plate 12 and a longer clasping portion 30a, 30b extending from the respective short portions 28a, 28b substantially parallel to the plate 12. The upper or first grip 26a extends from the second surface 24 of the plate 12 adjacent the upper end 14 and first edge 18 thereof, while the lower or second grip 26b extends from the second surface 24 of the plate 12 toward the lower end 16 and adjacent the second edge 20 thereof. The gap between the clasp 30a of the first or upper grip 26a and the plate 12 defines an open side 32a facing the second edge 20 of the plate 12, while the gap between the clasp 30b of the second or lower grip 26b and the plate 12 defines an open side 32b facing the first edge 18 of the plate 12.

It will be seen that the upstanding portion 28a and clasp portion 30a of the grip 26a form somewhat more than a 90° angle due to the upstanding portion 28a being attached to the first edge 18 of the plate 12, while its clasp portion 30a is generally centered over the second surface 24 of the plate 12. The same is true of the grip 26b relative to the second edge 20 of the plate 12. Accordingly, an additional brace plate of steel or other suitable material 34a, 34b may be installed (welded, etc.) within each grip 26a and 26b. These brace plates 34a, 34b form more precise 90° angles to provide a more accurate fit of the two grips 26a and 26b on a member having a square or rectangular cross section. Moreover, the lower or attachment ends of the brace plates 34a, 34b are laterally spaced apart from the attachment ends of the upstanding portions 28a, 28b of the two grips 26a, 26b, thereby greatly increasing the bending resistance of the grips.

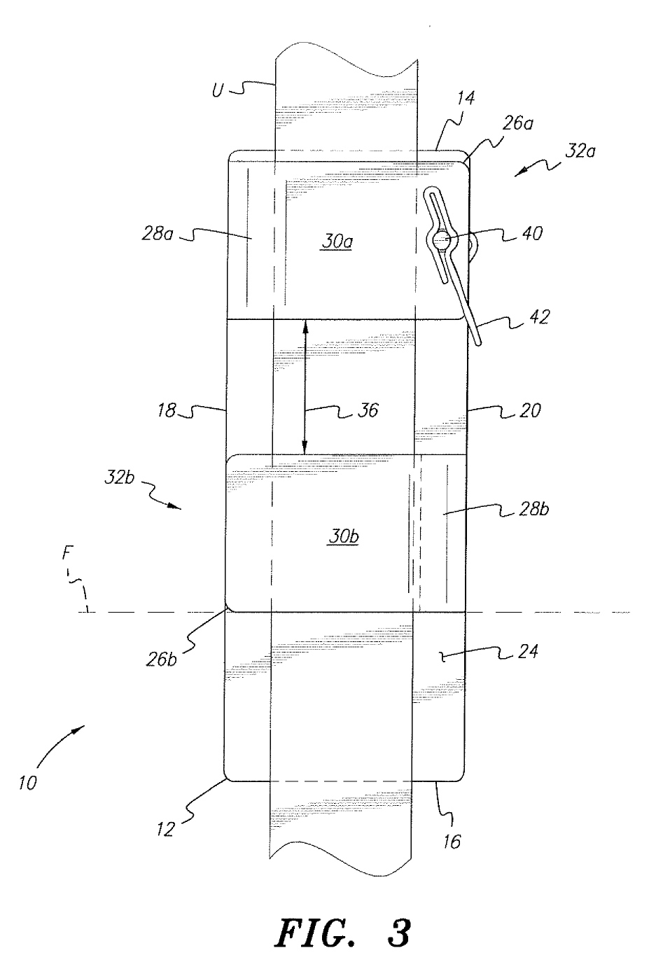

The two grips 26a and 26b define a column attachment passage A that extends concentrically substantially through the centers of the two grips and generally along the vertical centerline of the plate 12. The lower or second grip 26b is spaced apart from the upper or first grip 26a, as noted further above. The gap 36 (shown in FIGS. 2 and 3) or space between the two grips 26a, 26b is sufficiently wide to allow a conventional upright post on the lift platform of a personnel lift, e.g., the post U illustrated in FIG. 2, to pass between the two grips 26a, 26b when the support bracket 10 is turned so that the column attachment passage A is normal to the elongate axis of the upright post U. Once the support bracket 10 is abutted against the upright U with the two grips 26a, 26b straddling the upright U, the bracket 10 may then be rotated to place the two clasp portions 30a and 30b of the grips 26a, 26b behind the upright U, i.e., on the opposite side of the upright U from the plate 12, generally as shown in FIG. 3.

A lock pin passage 38a is formed through the plate 12 underlying the distal end of the clasp portion 30a of the upper or first grip 26a adjacent to the second edge 20 of the plate 12. A corresponding lock pin passage 38b is formed through the distal portion of the clasp 30a, the two passages 38a and 38b being concentrically aligned with one another. A lock pin 40 is removably installed through the two passages 38a, 38b to prevent the support bracket 10 from rotating about the post or upright U after it has been installed thereon. The securely installed bracket 10, with lock pin 40 installed therein, is shown in FIGS. 3 and 4 of the drawings. The lock pin may comprise any suitable type of rod, bolt, pin, or the like, but is most preferably a wire lock type pin with a selectively openable and closable wire bail 42 pivotally secured to the head of the pin. The bail 42 clips over the opposite distal end of the pin 40 to hold the pin in place after installation.

The first surface 22 of the plate 12, i.e., the side or surface opposite the upper and lower grips 26a and 26b, has a panel support member 44 extending outwardly therefrom. The panel support member 44 is substantially normal to the plane of the plate 12, and may comprise any suitably sturdy structure as desired. In the exemplary support bracket 10, the panel support member 44 comprises a length of rectangular section steel tube, the flat upper surface 46 of the tube serving as the panel support flange of the device. The distal end of the panel support flange 46 has a raised retaining flange or lip 48 extending upwardly therefrom to prevent a panel being carried or supported by the device from slipping from the panel support flange or surface.

The support bracket 10 is used by first installing the device upon an upright U or similar structure of the personnel lift L, with the panel support member 44 extending outwardly therefrom. The lower or second grip 26b rests upon the floor F of the personnel lift, generally as shown in FIGS. 3 and 4. The lock pin 40 is then installed to prevent the bracket 10 from rotating and falling from the upright U. Preferably, two such brackets 10 are installed upon spaced apart uprights U, generally as shown in FIG. 1 of the drawings. The bracket 10 may then be used to hold, carry, lift, and/or transport large and heavy panels P from the surface to their intended installation point or location in a building structure or the like, generally as shown in FIG. 1. When the panel transport operation has been completed, the bracket(s) 10 is/are quickly and easily removed from the personnel lift by reversing the procedure described further above, so that they may be retained by the owner or worker for reuse in future operations.

It is to be understood that the present invention is not limited to the embodiment described above, but encompasses any and all embodiments within the scope of the following claims.

I claim:

1. A support bracket for rigid panels, comprising:
a rigid plate having an upper end, a lower end opposite the upper end, a first edge, a second edge opposite the first edge, a first surface, and a second surface opposite the first surface;
an upper grip extending from the second surface of the plate adjacent the upper end and first edge thereof, the upper grip having an open side facing the second edge of the plate;
a lower grip extending from the second surface of the plate adjacent the lower end and second edge thereof, the lower grip having an open side facing the first edge of the plate, the lower grip being spaced apart from the upper grip and defining a column insertion slot therebetween, the upper grip and the lower grip together defining a concentric column attachment passage; and
a panel support member extending from the first surface of the plate.

2. The support bracket for rigid panels according to claim 1, wherein the panel support member is a rectangular steel tube having a flat upper surface, the upper surface of the panel support member defining a panel support flange.

3. The support bracket for rigid panels according to claim 1, wherein the rigid plate has a lock pin passage extending therethrough and at least one grip has a lock pin passage extending therethrough, the lock pin passage of the at least one grip being concentric with the lock pin passage of the rigid plate, the support bracket further comprising a lock pin selectively installed through the lock pin passages of the rigid plate and the at least one grip.

4. The support bracket for rigid panels according to claim 3, wherein the lock pin comprises a wire lock pin having a selectively openable and closable bail.

5. The support bracket for rigid panels according to claim 1 wherein the panel support member has a distal end having a raised retaining lip extending upward therefrom.

6. The support bracket for rigid panels according to claim 1, wherein each said grip further includes a brace plate.

7. The support bracket for rigid panels according to claim 1, wherein the plate, the upper grip, and the lower grip are formed of steel plate.

8. A support bracket for rigid panels, comprising:
a rigid plate having an upper end, a lower end opposite the upper end, a first edge, a second edge opposite the first edge, a first surface, and a second surface opposite the first surface;
an upper grip extending from the second surface of the plate adjacent the upper end and first edge thereof;
a lower grip extending from the second surface of the plate adjacent the lower end and second edge thereof; and
a panel support member extending from the first surface of the plate, the panel support member being a rectangular steel tube having a flat upper surface and a panel support flange extending normal to the upper surface.

9. The support bracket for rigid panels according to claim 8, wherein:
the upper grip has an open side facing the second edge of the plate; and
the lower grip has an open side facing the first edge of the plate, the lower grip being spaced apart from the upper grip and defining a column insertion slot therebetween, the upper grip and the lower grip together defining a concentric column attachment passage.

10. The support bracket for rigid panels according to claim 8, wherein the rigid plate has a lock pin passage extending therethrough and at least one grip has a lock pin passage extending therethrough, the lock pin passage of the at least one grip being concentric with the lock pin passage of the rigid plate, the support bracket further comprising a lock pin selectively installed through the lock pin passages of the rigid plate and the at least one grip.

11. The support bracket for rigid panels according to claim 10, wherein the lock pin comprises a wire lock pin having a selectively operable and closable bail.

12. The support bracket for rigid panels according to claim 8 wherein the panel support member has a distal end having a raised retaining lip extending upward therefrom.

13. The support bracket for rigid panels according to claim 8, wherein each said grip further includes a brace plate.

14. The support bracket for rigid panels according to claim 8, wherein the plate, the upper grip, and the lower grip are formed of steel plate.

15. A support bracket for rigid panels, comprising:
a forwardly disposed panel support member;
a rearwardly disposed upper grip opposite the panel support member, the upper grip having an open side, the upper grip being formed of steel sheet;
a rearwardly disposed lower grip opposite the panel support member, the lower grip being spaced apart from the upper grip, the lower grip having an open side laterally opposite the open side of the upper grip, the lower grip being formed of steel sheet, at least one of the grips having a lock pin passage extending therethrough; and
a lock pin selectively installed through the lock pin passage.

16. The support bracket for rigid panels according to claim 15, further including a rigid steel plate having an upper end, a lower end opposite the upper end, a first edge, a second edge opposite the first edge, a first surface, and a second surface opposite the first surface the panel support member extending from the first surface of the plate and the upper grip extending from the second surface of the plate adjacent the upper end and first edge thereof, the upper grip having an open side facing the second edge of the plate, the lower grip extending from the second surface of the plate adjacent the lower end and second edge thereof, the lower grip having an open side facing the first edge of the plate, the lower grip being spaced apart from the upper grip and defining a column insertion slot therebetween, the upper grip and the lower grip together defining a concentric column attachment passage.

17. The support bracket for rigid panels according to claim 15 wherein the panel support member is a rectangular steel tube having a flat upper surface, the upper surface of the panel support member defining a panel support flange.

18. The support bracket for rigid panels according to claim 15, wherein the lock pin comprises a wire lock pin having a selectively openable and closable bail.

19. The support bracket for rigid panels according to claim 15 wherein the panel support member has a distal end having a raised retaining lip extending upward therefrom.

20. The support bracket for rigid panels according to claim 15, wherein each said grip further includes a brace plate.
